(19) United States
(12) Patent Application Publication
(10) Pub. No.: US 2022/0400488 A1
(43) Pub. Date: Dec. 15, 2022

(54) NETWORK ENTITY AND RESOURCE ARRANGEMENT METHOD

(71) Applicant: Lite-On Technology Corporation, Taipei (TW)

(72) Inventors: Han-Sheng Hung, Taipei (TW); Shih-Hao Tung, Taipei (TW)

(73) Assignee: Lite-On Technology Corporation, Taipei (TW)

(21) Appl. No.: 17/471,181

(22) Filed: Sep. 10, 2021

(30) Foreign Application Priority Data
Jun. 9, 2021 (TW) 110121033

(51) Int. Cl. H04W 72/04; H04W 24/10

(52) U.S. Cl. CPC H04W 72/0453; H04W 24/10

(57) ABSTRACT

A network entity and a resource arrangement method are provided. In the method, a resource use condition of a radio resource is obtained. The radio resource is configured with multiple subcarriers. A subcarrier spacing between the subcarriers is adjusted according to the resource use condition.

### CROSS-REFERENCE TO RELATED APPLICATION

This application claims the priority benefit of Taiwanese application no. 110121033, filed on Jun. 9, 2021. The entirety of the above-mentioned patent application is hereby incorporated by reference herein and made a part of this specification.

### BACKGROUND

### Technical Field

The disclosure relates to radio resource arrangement; particularly, the disclosure relates to a network entity and a resource arrangement method.

### Description of Related Art

The 3rd Generation Partnership Project (3GPP) published the 5th Generation (5G) New Radio (NR) mobile communications standard in June, 2018, laying a foundation for the new 5G end-to-end network architecture and establishing a complete 5G Release 15 standard.

However, compared to the 4th Generation (4G) Long-Term Evolution (LTE), the 5G NR has a wider frequency spectrum coverage. For example, FIG. 1 is a schematic diagram of the conventional use of 5G frequency spectrum in various countries. With reference to FIG. 1, the 5G NR frequency spectrum includes a low frequency band below 1 GHertz (Hz), an intermediate frequency band below 6 GHz, and a high frequency band from 30 GHz to 300 GHz millimeter wave (mmWave). For the low frequency band, it is generally divided into uplink (UL) and downlink (DL), each provided with an independent bandwidth, in frequency-division duplexing (FDD). For the intermediate frequency band, it has wider coverage and transmittance than the high frequency millimeter waves, has a frequency at about 3.5 GHz or 5.8 GHz, and operates in time-division duplexing (TDD). For the high frequency band, if the transmission rate is to be increased to be higher than 10 Gbps, the feature of millimeter wave is required to be used. It has a frequency at about 28 GHz or 38 GHz, and operates in TDD.

Notably, the 5G network inherits orthogonal frequency division multiplex (OFDM) employed by the 4G network. With different properties of frequency bands from the low frequency band to the high frequency band, application scenarios for the frequency spectrum may be generally divided into four modes. To operate in different frequency bands, the 3GPP provides the following configurations of subcarrier spacing (SCS). FIG. 2 shows frequency spectrum configurations in four conventional application scenarios. With reference to FIG. 2, a bandwidth BW1 with a subcarrier spacing SCS1 of 15 kHz is 50 MHz, and is applicable to outdoor large coverage (with requirements for medium transmission rate and low frequency). A bandwidth BW2 with a subcarrier spacing SCS2 of 30 kHz is 50 MHz, or a bandwidth BW3 with a subcarrier spacing SCS3 of 60 kHz is 200 MHz, and is applicable to outdoor general coverage (with requirements for high-speed transmission and intermediate frequency). Moreover, a bandwidth BW4 with a subcarrier spacing SCS4 of 120 kHz is 400 MHz, and is applicable to special coverage (with requirements for ultra-high-speed transmission and high frequency).

As far as the 4G LTE is concerned, its main application scenario is carrier frequencies below 3 GHz, while the subcarrier spacing determined for the LTE is fixed at 15 kHz. However, since the 5G frequency spectrum coverage is far greater than the range used by the 4G network and may need to face more application scenarios, the configuration of a single subcarrier spacing cannot satisfy various kinds of application scenarios, for example, a large-scale internet of things or a low-latency application scenario. For the different requirements of the 5G network, the 3GPP has formulated a set of numerologies to correspond to the configuration of subcarrier spacing.

One of the foci of orthogonal frequency division multiple (OFDM) adopted by 5G NR is the selection of numerology. The numerology mainly indicates the configuration of subcarrier and cyclic prefix (CP) selected for OFDM. The 5G NR supports different configurations of subcarrier spacing, including 15 kHz, 30 kHz, 60 kHz, 120 kHz, and 240 kHz. The configuration of cyclic prefix typically adopts a normal cyclic prefix. Through the selection of different numerologies, the balance between carrier frequency spectrum, cell coverage, transmission rate, latency, and reliability can be taken into account.

In addition, FIG. 3 is a schematic diagram of a conventional resource block. With reference to FIG. 3, the number of 5G resource blocks (RB) is related to both of the subcarrier spacing and the total bandwidth. If an OFDM signal is used, there will be a multitude of subcarriers SC in each bandwidth. For ease of management, a resource covering 12 consecutive subcarriers SC in the frequency domain and lasting one timeslot SL in the time domain may be referred to as one resource block (RB). A radio resource provided by a base station to each user equipment takes RB as the smallest unit. For example, if the amount of data of a first user equipment is less, the base station may allocate only 1 RB to the first user equipment. If the amount of data of a second user equipment is larger, the base station may allocate 100 RBs to the second user equipment.

Table (1) is an example showing a correspondence table between the subcarrier spacing and the number of RBs:

TABLE (1)

| Subcarrier | | | | | |
|---|---|---|---|---|---|
| spacing | Total bandwidth | | | | |
| (kHz) | (MHz)→ | 50 | 60 | 80 | 100 |
| 15 | Number of RBs | 270 | | | |
| 30 | Number of RBs | 133 | 162 | 217 | 273 |
| 60 | Number of RBs | 65 | 79 | 107 | 135 |
| 120 | Number of RBs | 32 | | | 66 |

For example, in a case where the subcarrier spacing is 30 kHz, if the total bandwidth is 50 MHz, the maximum number of RBs is 133. If the total bandwidth is 100 MHz, the maximum number of resource blocks increases to 273, which means that under the maximum limit of resource use, a certain user equipment may obtain 273 resource blocks by arrangement to accordingly achieve the greatest transmission rate. However, the base station in the peak period may serve more user equipments, and the 273 resource blocks are required to be allocated to all the user equipments. As a result, the number of resource blocks obtained by each user equipment decreases, and the average transmission rate of the user equipment decreases.

On the other hand, the OFDM system is effective in eliminating inter-symbol interference (ISI) caused by multipath. With this feature, a high frequency spectrum utilization rate can be achieved. However, since the OFDM system is relatively sensitive to phase noise, as the subcarrier density increases, the signal-to-interference-plus-noise ratio (SINR) decreases, impairing the system performance. The phase noise has different properties in different frequency bands, and as the frequency increases, the phase noise increases. In addition, under high-speed movement, in the OFDM system, rapid changes occur in the wireless signal transmission channel model, and signals are distorted because of channel estimation errors or Doppler shift, increasing the data transmission block error rate (BLER). By increasing the signal strength to alleviate the BLER, although the signal strength is increased, inter-carrier interference (ICI) is also increased at the same time, and the optimal signal strength requires to be achieved by adjustment according to the mobility speed.

Notably, the existing radio resource arrangement mechanism still cannot satisfy the changing application scenarios. Even if a numerology is provided for setting the configuration of subcarrier spacing, typically the base station selects only one configuration to operate after the station launch, still lacking flexibility and not being applicable to changes in the application scenarios. Moreover, the 5G network may further face a changeable and complex environment in the future. At that time, a single configuration may not only affect performance, but also compromise the effective use of frequency spectrum.

### SUMMARY

An embodiment of the disclosure provides a network entity and a resource arrangement method, in which the resource arrangement may be adjusted according to the actual condition of the radio resource to meet the current requirements of the application scenario.

According to an embodiment of the disclosure, a resource arrangement method is applicable to a network entity. The resource arrangement method includes (but is not limited to) the following. A resource use condition of a radio resource is obtained. The radio resource is configured with multiple subcarriers. A subcarrier spacing (SCS) between the subcarriers is adjusted according to the resource use condition.

According to an embodiment of the disclosure, a network entity includes (but is not limited to) a storage device and a processor. The storage device is configured to store a programming code. The processor is coupled to the storage device. The processor is configured to be loaded with and execute the programming code to obtain a resource use condition of a radio resource, and adjust a subcarrier spacing between multiple subcarriers according to the resource use condition. The radio resource is configured with the subcarriers.

Based on the above, according to the embodiments of the disclosure, in the network entity and the resource arrangement method, the configuration of the subcarrier spacing can be adjusted in response to the resource use condition. Accordingly, application in a changeable environment is achieved, and the frequency spectrum utilization rate can be increased.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of the conventional use of 5G frequency spectrum in various countries.

FIG. 2 shows frequency spectrum configurations in four conventional application scenarios.

FIG. 3 is a schematic diagram of a conventional resource block.

FIG. 4 is a schematic diagram of a communication system according to an embodiment of the disclosure.

FIG. 5 is a block diagram of elements of the core network entity according to an embodiment of the disclosure.

FIG. 6 is a block diagram of elements of the base station according to an embodiment of the disclosure.

FIG. 7 is a flowchart of a resource arrangement method according to an embodiment of the disclosure.

FIG. 8 is a schematic diagram showing a corresponding relationship between subcarrier spacing and timeslots in the convention.

FIG. 9 is a schematic diagram of signaling of a measurement report according to an embodiment of the disclosure.

FIG. 10 is a flowchart of a resource arrangement method according to an embodiment of the disclosure.

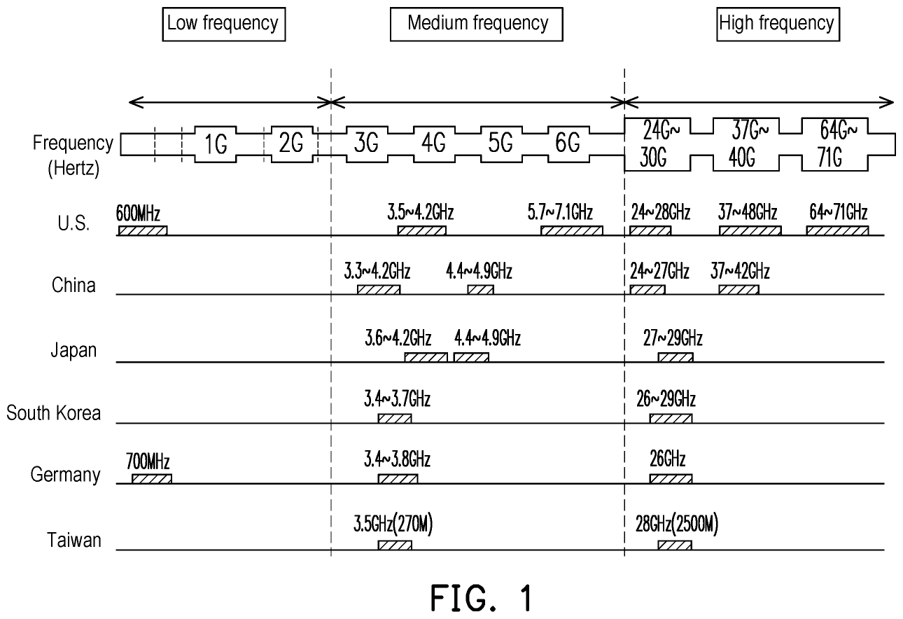

### DESCRIPTION OF THE EMBODIMENTS

FIG. 4 is a schematic diagram of a communication system 1 according to an embodiment of the disclosure. With reference to FIG. 4, the communication system 1 includes (but is not limited to) one or more user equipments 50 and one or more network entities 70 (e.g., a core network entity 80 and/or a base station 100). The communication system 1 may be applied to Long-Term Evolution (LTE), LTE Advanced (LTE-A), 5G New Radio (NR), or other generations of mobile networks.

The user equipment 50 may have multiple implementation aspects. For example, the user equipment 50 may include (but is not limited to) mobile stations, advanced mobile stations (AMS), telephone devices, customer-premises equipment (CPE), and wireless sensors.

The (cellular) core network entity 80 is coupled to the base station 100. For different generations of mobile networks, the implementation aspects of the core network entity 80 and the base station 100 may be different. For example, regarding the 4G network, the core network entity 80 may be a home subscriber server (HSS) or a mobility management entity (MME), and the base station 100 may be Home evolved Node B (HeNB), evolved Node B (eNB), an advanced base station (ABS), or a base transceiver system (BTS). Regarding the 5G network, the core network entity 80 may be an authentication server function (AUSF) or an access and mobility management function (AMF), and the base station 100 may be gNodeB (gNB). However, in some embodiments, the core network entity 80 may also be any server in the core network.

In an embodiment, the core network entity 80 may further operate an operation support system (OSS) or other platforms related to operations, administration, and maintenance (OAM) of the mobile network, and may accordingly send instructions or configurations related to radio resource arrangement to the base station 100. In an embodiment, the base station 100 is configured to provide network access services to one or more user equipments 50.

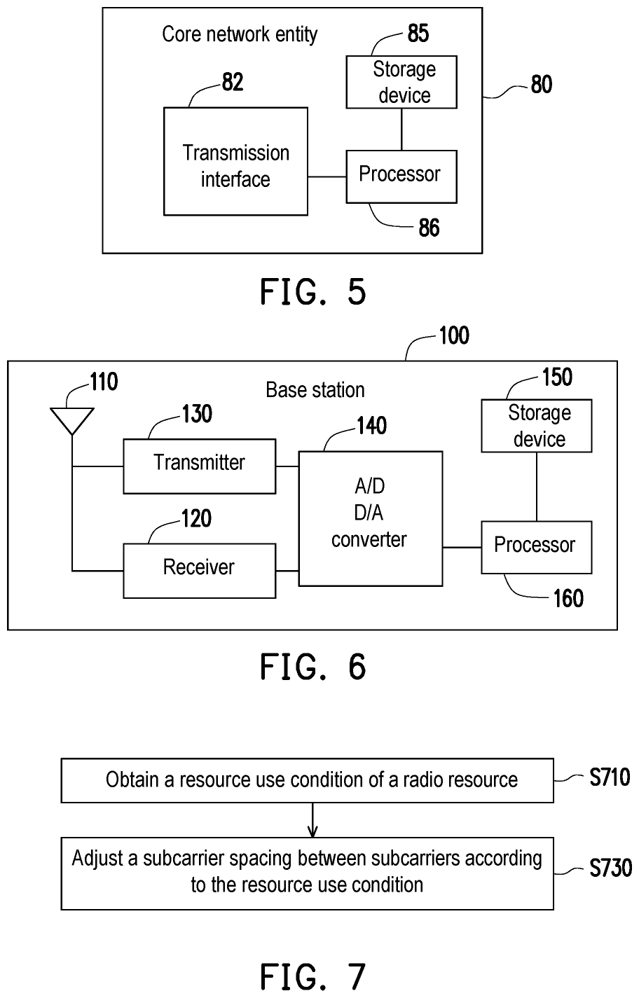

FIG. 5 is a block diagram of elements of the core network entity 80 according to an embodiment of the disclosure. The core network entity 80 includes (but is not limited to) a transmission interface 82, a storage device 85, and a processor 86.

The transmission interface 82 may be a transmission interface that supports Ethernet, optical network, Wi-Fi, mobile network, or other wired or wireless communication technologies. In an embodiment, the transmission interface 82 is configured to be connected to the base station 100 and transmit messages to or receive messages from the base station 100. For example, the core network entity 80 and the base station 100 transmit messages through the S1 or N1 interface.

The storage device 85 may be any type of fixed or mobile random access memory (RAM), read-only memory (ROM), flash memory, or similar elements or a combination of the above elements. In an embodiment, the storage device 85 is configured to store a programming code, network configuration, frequency spectrum information, measurement report, resource use condition, subcarrier spacing, buffer data, or permanent data, and the content of data thereof will be introduced later.

The processor 86 is coupled to the transmission interface 82 and the storage device 85. The processor 86 is configured to process digital signals and execute programs in the embodiment of the disclosure, and is configured to be loaded with and execute the programming code and/or software modules stored in the storage device 85. The function of the processor 86 may be embodied by using programmable units (e.g., a central processing unit (CPU), microprocessor, microcontroller, digital signal processing (DSP) chip, or field programmable gate array (FPGA)). The function of the processor 86 may also be embodied by an independent electronic device or an integrated circuit (IC), and the operation of the processor 86 may also be embodied by software.

FIG. 6 is a block diagram of elements of the base station 100 according to an embodiment of the disclosure. With reference to FIG. 6, the base station 100 includes (but is not limited to) one or more antennas 110, a receiver 120, a transmitter 130, an analog-to-digital (A/D)/digital-to-analog (D/A) converter 140, a storage device 150, and a processor 160.

The receiver 120 and the transmitter 130 are configured to respectively receive uplink signals and transmit downlink signals through the antenna 110 wirelessly. The receiver 120 and the transmitter 130 may also perform analog signal processing operations such as low noise amplification, impedance matching, frequency mixing, frequency up-conversion or down conversion, filtering, amplification, and the like. The analog-to-digital/digital-to-analog converter 140 is coupled to the receiver 120 and the transmitter 130. The analog-to-digital/digital-to-analog converter 140 is also configured to convert an analog signal format into a digital signal format during an uplink signal processing period, and convert a digital signal format into an analog signal format during a downlink signal processing period.

For the implementation aspects of the storage device 150, reference may be made to the description of the storage device 85, which will not be repeated herein. The storage device 150 stores a programming code, device configuration, codebook, network configuration, frequency spectrum information, measurement report, subcarrier spacing, or other buffered or permanent data, and stores a software module such as a radio resource control (RRC) layer, packet data convergence protocol (PDCP) layer, radio link control (RLC) layer, media access control (MAC) layer, physical layer (PHY), and/or other software modules related to communication protocols.

The processor 160 is coupled to the analog-to-digital/digital-to-analog converter 140 and the storage device 150. The processor 160 is also configured to process digital signals and execute programs according to an exemplary embodiment of the disclosure, and may be loaded with and execute the programming code and/or software module stored in the storage device 150. For the related hardware or software that embodies the function of the processor 160, reference may be made to the description of the processor 86, which will not be repeated herein.

The method according to the embodiment of the disclosure accompanied with the devices and components thereof in the communication system 1 will be described below. Each flow in the method of the embodiment of the disclosure may be adjusted accordingly depending on the implementation, and is not limited thereto. In addition, for ease of description below, the processor 160 of the base station 100 will be taken as an example serving as the subject of operations. However, all or part of the operations on the processor 160 may also be performed by the processor 86 of the core network entity 80, and the data related to resource arrangement may be obtained through the base station 100.

FIG. 7 is a flowchart of a resource arrangement method according to an embodiment of the disclosure. With reference to FIG. 7, the processor 160 may obtain a resource use condition of a radio resource (step S710). Specifically, the radio resource is a resource used by the base station 100 and/or the user equipment 50 in wirelessly transmitting or receiving signals. The radio resource is related to the occupied bandwidth in the frequency domain and the occupied period in the time domain. Depending on different application requirements, the radio resource may takes a resource block (RB) or other combinations occupying a bandwidth (e.g., a specific frequency, a frequency band, or a combination thereof) and occupying time (e.g., a timeslot, a time interval, or a combination thereof) as a unit, which is not limited by the embodiment of the disclosure.

In addition, the radio resource is configured with multiple subcarriers. That is, the network entity 70 employs multi-carrier transmission technology. For example, the 4G or 5G network adopts the orthogonal frequency-division multiplexing (OFDM) technology. The OFDM employs a large number of closely adjacent orthogonal subcarriers, and each subcarrier is modulated at a low symbol rate adopting a corresponding modulation scheme.

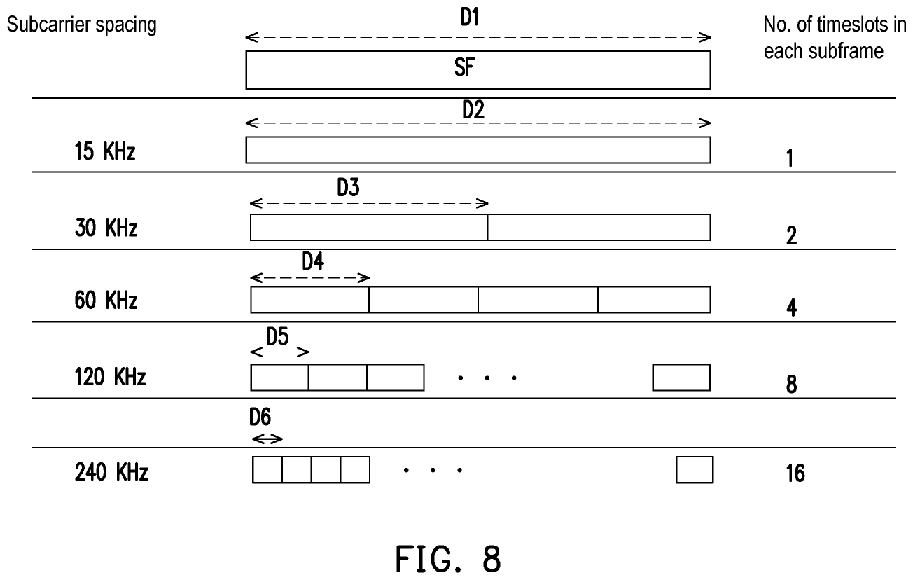

Generally speaking, any two adjacent subcarriers are configured with a specific subcarrier spacing (SCS). For example, FIG. 8 is a schematic diagram showing a corresponding relationship between subcarrier spacing and timeslots in the convention. With reference to FIG. 8, in terms of frame design, the LTE frame design is remained in the 5G NR, in which every 10 ms (milliseconds) is divided into a frame on the time axis, and a period D1 of 1 ms is taken as a subframe SF. According to different numerological configurations, the subframe SF may be further divided into one or more timeslots. The timeslot is a time unit of general scheduling. Under the configuration of normal cyclic prefix (CP), one timeslot includes 14 OFDM symbols. Accordingly, the length of the timeslot differs as the configuration of subcarrier spacing differs. In addition, to match the length of the subframe SF, the cyclic prefix of a specific symbol is slightly adjusted.

For example, Table (2) is a numerological configuration of the 5G NR (with μ denoting the numerology, or referred to as number, where the subcarrier spacing is 2^{μ}×15 kHz):

TABLE (2)

| | Subcarrier | Timeslot | Symbol period | | Cell |
|---|---|---|---|---|---|
| | spacing | period | (microseconds | Type of cyclic | coverage |
| μ | (kHz) | (ms) | (μs)) | prefix | (meter) |
| 0 | 15 | 1 | 66.67 | Normal | 1407 |
| 1 | 30 | 0.5 | 33.33 | Normal | 703 |
| 2 | 60 | 0.25 | 16.67 | Normal/Extended | 351 |
| 3 | 120 | 0.125 | 8.33 | Normal | 175 |
| 4 | 240 | 0.625 | 4.17 | Normal | 87 |

With reference to FIG. 8 and Table (2) together, if the subcarrier spacing is 15 kHz, the subframe SF includes 1 timeslot (of which a period D2 is equal to the period D1). If the subcarrier spacing is 30 kHz, the subframe SF includes 2 timeslots (of which a period D3 is equal to a half of the period D1). If the subcarrier spacing is 60 kHz, the subframe SF includes 4 timeslots (of which a period D4 is equal to a quarter of the period D1). If the subcarrier spacing is 120 kHz, the subframe SF includes 8 timeslots (of which a period D5 is equal to one-eighth of the period D1). If the subcarrier spacing is 240 kHz, the subframe SF includes 16 timeslots (of which a period D6 is equal to one-sixteenth of the period D1).

Note that, the subcarrier spacing is not limited to the numerologies listed in Table (2). In addition, depending on different application requirements, the base station 100 may also adopt other frequency-division multiplex (FDM) technologies.

In an embodiment, the resource use condition includes a carrier frequency, bandwidth, latency, phase noise, mobility speed, cell coverage, and/or the number of user equipments 50 served by the base station 100 related to the radio resource. In some embodiments, the resource use condition may also be other conditions related to accessing the radio resource, for example, a data error rate, number of failures in accessing resources, signal quality, type of encoding used, number of resources, the environment of the user equipment 50, or number of reconnections.

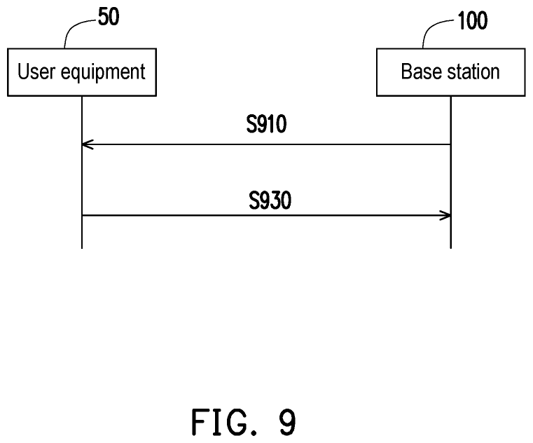

In an embodiment, the processor 160 may determine the resource use condition according to a measurement report fed back by the user equipment 50. For example, FIG. 9 is a schematic diagram of signaling of a measurement report according to an embodiment of the disclosure. The base station 100 submits a request for measurement report to the user equipment 50 (step S910), and the user equipment 50 feeds back a measurement report to the base station 100 (step S930). For example, the measurement of reference signal received power (RSRP) may be performed and reported in a physical layer (through channel state information (CSI)) or a RRC layer (through the measurement report). In some embodiments, in response to specific triggers (e.g., a timer or minimization of drive test (MDT)), the user equipment 50 may also actively transmit the measurement report to the base station 100.

In an embodiment, the measurement report includes signal strength, signal quality, signal-to-noise ratio/signal-to-interference ratio, and other indicators. For example, reference signal received power (RSRP), reference signal received quality (RSRQ), and signal-to-interference-plus-noise ratio (SINR) of a physical cell identity (PCI) having a corresponding cell.

In an embodiment, a degree (related to a value, range, or other measurement units) of one or more indicators recorded in the measurement report corresponds to a degree of the resource use condition. The degree of the resource use condition may be divided into one or more types. For example, the degree of the resource use condition includes good and poor types. For another example, the degree of the resource use condition includes 1 to 10 types, where a lower/less value represents a worse condition, and a higher/greater value represents a better condition. For yet another example, the degree of the resource use condition includes 5 types, where there exists only a numerical difference (only serving for numbering the numerologies) between the types but no difference in being good or bad. For still another example, the degree of the resource use condition is distinguished by a specific code.

In an embodiment, the processor 160 may convert the degree of the indicator recorded in the measurement report into a degree of the resource use condition by querying a correspondence table or formula. For example, Table (3) is a correspondence table between indicators and resource use conditions:

TABLE (3)

| | | RSRP (decibel- | | |
|---|---|---|---|---|
| | | milliwatts | RSRQ (decibels | |
| Indicator type | | (dBm)) | (dB)) | SINR (dB) |
| Resource use | Excellent | ≥−80 | ≥−80 | ≥−80 |
| condition | Good | −80 to −90 | −10 to −15 | 13 to 20 |
| | Average | −90 to −100 | −15 to −20 | 0 to 13 |
| | Poor | ≤−100 | ≤−20 | ≤0 |

For another example, the processor 160 compares the value or range of the indicator with a corresponding threshold, and determines the degree of the corresponding resource use condition according to the comparison result.

In an embodiment, in addition to indicators (e.g., RSRP and RSRQ) obtained directly from the measurement report, some indicators may be transformed into other results by using specific formulae. For example, a received signal strength indication (RSSI) may be obtained from the RSRP and RSRQ.

In an embodiment, according to a cell planning of the base station 100, application service requirements, inputs by an operator, or measurement results by a sensor, the processor 160 may obtain the resource use condition, for example, the supported frequency band of the base station 100 or the user equipment 50, the bandwidth requirement of image streaming, or the mobility speed obtained based on position information of a satellite locator.

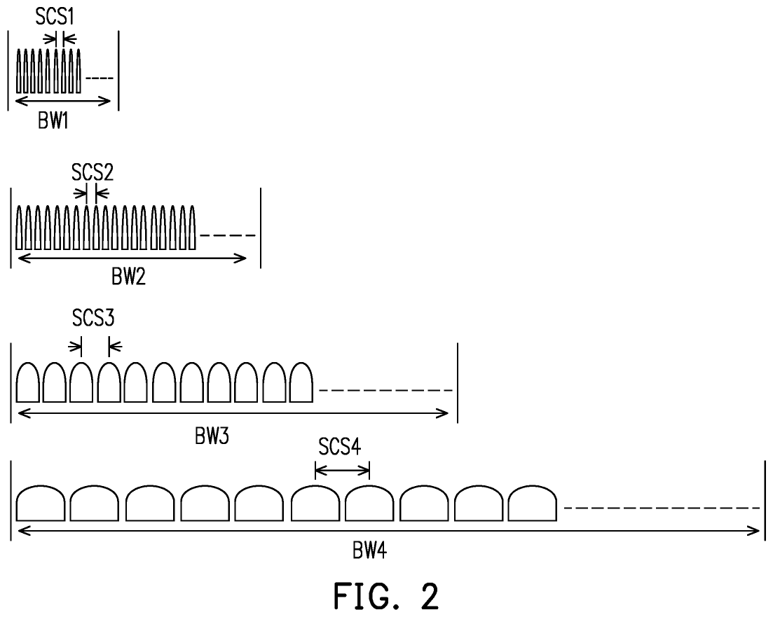

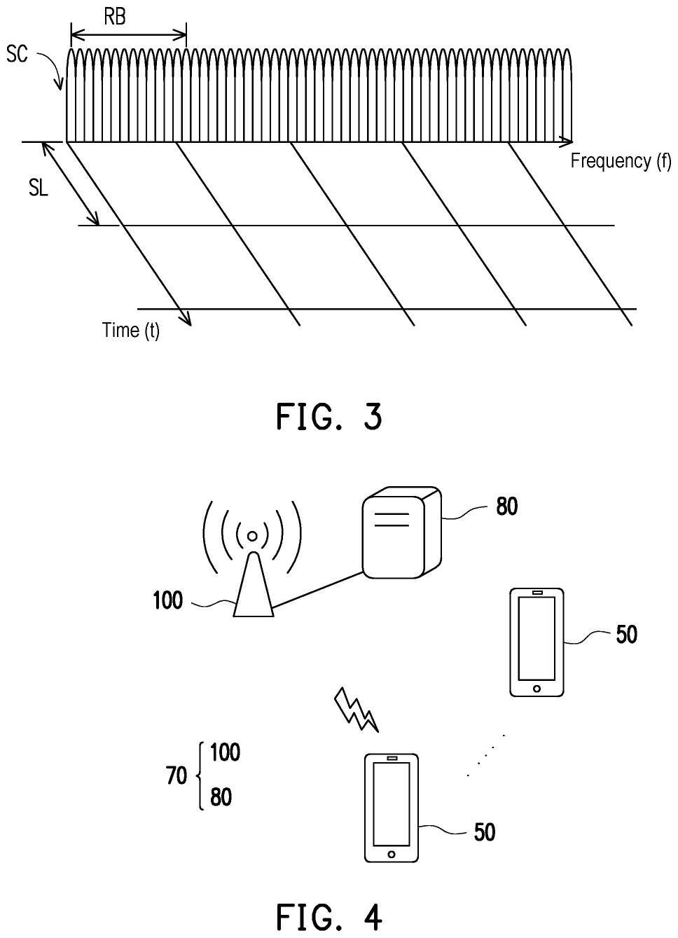

With reference to FIG. 7, the processor 160 may adjust the subcarrier spacing between the subcarriers according to the resource use condition (step S730). Specifically, taking FIG. 2 as an example, the radio resources (distinguished into the total bandwidths BW1 to BW4, assumed with the same occupied time) occupied by different subcarrier spacings SCS1 to SCS4 are different. Generally speaking, a smaller subcarrier spacing is applicable to application scenarios with wider cell coverage, lower frequency band, and less transmission rate. On the other hand, a larger subcarrier spacing is applicable to application scenarios with narrower cell coverage, higher frequency band, and greater transmission rate. Different from the fixed subcarrier spacing adopted in the conventional technology or the fixed subcarrier spacing used after the station launch, in the embodiment of the disclosure, the corresponding application scenario may be obtained through the resource use condition, and the subcarrier spacing may be adjusted accordingly, thereby providing an appropriate subcarrier spacing to meet the requirements in the current application scenario.

The NR or other communication systems support multiple options of subcarrier spacing (which may be distinguished by using numerological numbering). When a relatively small subcarrier spacing is used, the symbol length is increased in inverse proportion. In the case of a relatively great symbol length, the cyclic prefix of the OFDM symbol may be relatively long more resistant to inter-symbol interference (ISI). Therefore, for a relatively small subcarrier spacing, the system may be relatively tolerant of influences of multipath delay extension.

Phase noise in the frequency domain causes signal jitter in the time domain. Typically, phase noise increases as the carrier frequency increases. Therefore, phase noise is relatively serious at higher carrier frequencies. When a phase change rate is slower relative to a duration of the OFDM symbol, the phase noise may be defined as a constant and may be compensated through estimation.

Based on the above properties, from another point of view, if the subcarrier spacing is smaller, the transmission delay is greater. On the other hand, if a larger subcarrier spacing is selected, an excess channel bandwidth may be caused. In addition, since the subcarrier spacing is inversely proportional to the duration of the OFDM symbol, as the subcarrier spacing increases, the length of the OFDM symbol and cyclic prefix decreases, making the system more prone to delay extension. Therefore, the subcarrier spacing should be as small as possible, and sufficient performance should be provided when phase noise occurs to achieve the ideal channel bandwidth.

There may exist multiple mechanisms for adjusting subcarrier spacing. In an embodiment, the resource use condition includes a carrier frequency, bandwidth, phase noise, and/or mobility speed related to the radio resource. In response to an increase of the degree corresponding to the resource use condition, the processor 160 may increase the subcarrier spacing. On the other hand, in response to a decrease of the degree corresponding to the resource use condition, the processor 160 may reduce the subcarrier spacing.

For example, as the frequency of a carrier frequency increases (i.e., the value corresponding to the degree of the resource use condition increases), the bandwidth used increases, and the phase noise increases. Therefore, the processor 160 may select a larger numerology number (e.g., μ in Table (2)) (corresponding to a larger subcarrier spacing), such that the number of resource blocks occupied under the same bandwidth is smaller, and a wider bandwidth is supported accordingly. In addition, if the subcarrier spacing is larger, the overall density of the subcarriers is lower, thereby increasing the tolerance to phase noise. By analogy, if the frequency of the carrier frequency is lower (i.e., the value of the degree is less), the processor 160 may select a smaller numerology number (corresponding to a smaller subcarrier spacing).

For another example, as the required bandwidth increases, the number of subcarriers increases. Therefore, the processor 160 may select a larger numerology number (corresponding to a larger subcarrier spacing), such that the number of resource blocks occupied under the same bandwidth is smaller, and a wider bandwidth is supported accordingly. By analogy, if the required bandwidth is smaller, the processor 160 may select a smaller numerology number (corresponding to a smaller subcarrier spacing).

For yet another example, as the phase noise increases, the length of the required cyclic prefix increases. Therefore, the processor 160 may select a larger numerology number (corresponding to a larger subcarrier spacing), such that the overall density of the subcarriers is lower, and the tolerance to phase noise is improved accordingly. By analogy, if the phase noise is smaller, the processor 160 may select a smaller numerology number (corresponding to a smaller subcarrier spacing).

For still another example, as the mobility speed of the user equipment 50 increases, the channel estimation errors increase, and the severity of Doppler shift increases. Therefore, the processor 160 may select a larger numerology number (corresponding to a larger subcarrier spacing), such that the overall density of the subcarriers is lower, and a greater Doppler shift is resisted accordingly. By analogy, if the mobility speed is slower, the processor 160 may select a smaller numerology number (corresponding to a smaller subcarrier spacing).

In another embodiment, the resource use condition includes the latency, cell coverage, and/or the number of user equipments 50 related to the radio resource. In response to an increase of the degree corresponding to the resource use condition, the processor 160 may reduce the subcarrier spacing. On the other hand, in response to a decrease of the degree corresponding to the resource use condition, the processor 160 may increase the subcarrier spacing.

For example, as the latency of the service demand decreases (i.e., the value of the degree decreases), the response time decreases. In addition, an immediate response to the resource scheduling is required. Therefore, the processor 160 may select a larger numerology number (corresponding to a larger subcarrier spacing), such that the length of the timeslot is smaller, and the response to resource scheduling is improved accordingly. By analogy, if the latency is longer (i.e., the value of the degree is greater), the processor 160 may select a smaller numerology number (corresponding to a smaller subcarrier spacing).

For another example, as the cell coverage currently provided by the base station 100 increases, the length of the required cyclic prefix increases. Therefore, the processor 160 may select a smaller numerology number (corresponding to a smaller subcarrier spacing), such that the length of the cyclic prefix is longer, and the cell coverage is increased accordingly. By analogy, if the cell coverage is smaller, the processor 160 may select a larger numerology number (corresponding to a larger subcarrier spacing).

For still another example, as the number of user equipments 50 currently served by the base station 100 increases, the number of resource blocks required to be scheduled increases. Therefore, the processor 160 may select a smaller numerology number (corresponding to a smaller subcarrier spacing), such that the number of resource blocks occupied under the same bandwidth is larger, and the radio resources may be allocated to more user equipments 50. By analogy, if the number of user equipments 50 is less, the processor 160 may select a larger numerology number (corresponding to a larger subcarrier spacing).

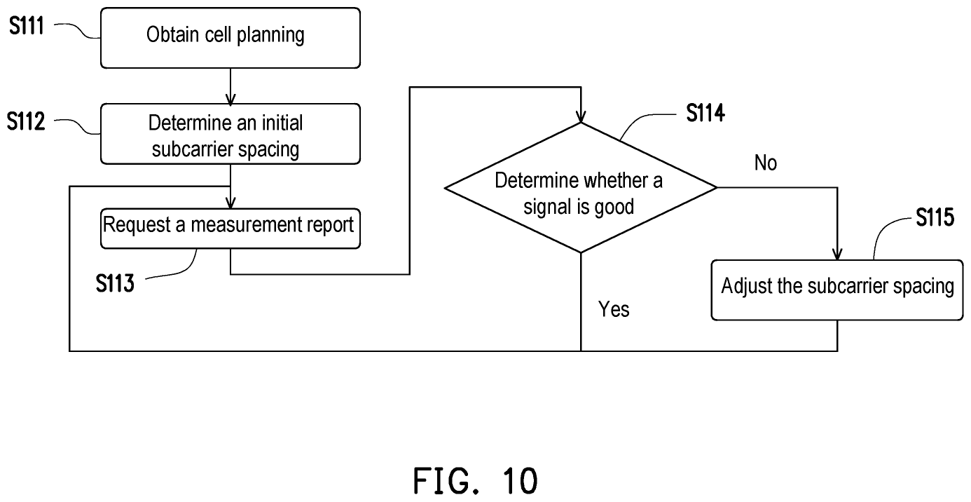

To facilitate a better understanding of the application scenarios, another embodiment is described below. FIG. 10 is a flowchart of a resource arrangement method according to an embodiment of the disclosure. With reference to FIG. 10, for ease of description below, the processor 86 of the core network entity 80 will be taken as an example serving as the subject of operations. However, all or part of the operations on the processor 86 may also be performed by the processor 160 of the base station 100.

The processor 86 obtains a cell planning of the base station 100 (step S111). The cell planning may be related to a carrier frequency, cell coverage, surrounding environment, customer complaints, or customer needs.

The processor 86 may determine an initial subcarrier spacing according to the cell planning of the base station 100 (step S112). For example, the 5G NR design is required to support from a low frequency band of 1 GHz to an ultra-high millimeter wave frequency band. Therefore, in the application of a low frequency band, it is taken into account that the cell coverage of the base station 100 is greater, and a lower subcarrier spacing and a longer cyclic prefix are required to be adopted to cope with a greater signal delay extension. For an ultra-high frequency band, a larger subcarrier spacing is adopted to cope with a greater phase noise. In addition, the expected coverage of the ultra-high frequency band is smaller, and the signal delay extension is smaller than in the lower frequency band.

The processor 86 may request the user equipment 50 to report the measurement report (step S113) through the base station 100. For example, the measurement report is channel state information (CSI) or a RSRP measurement report.

The processor 86 may determine whether the signal is good according to the measurement report reported by the user equipment 50 (step S114). For example, if the RSRP is greater than −70 dBm, it means that the signal is good and the degree of the resource use condition is relatively high. For another example, if the SINR is less than 0 dB, it means that the signal is poor and the degree of the resource use condition is relatively low.

The processor 86 may adjust the subcarrier spacing according to the degree of the resource use condition corresponding to the measurement report (step S115). For example, multiple degrees of the resource use condition correspond to different subcarrier spacings (or numerology numbers). For another example, the degree of the resource use condition may be substituted into a specific formula to obtain the corresponding subcarrier spacing. For still another example, multiple types of resource use conditions may be input to a classifier based on machine learning algorithms (e.g., random forest, artificial neural network (ANN), or support vector machine (SVM)), and an appropriate subcarrier spacing may be inferred accordingly.

In an embodiment, the processor 86 may first set the initial subcarrier spacing to a greater or the greatest value supported. If the subcarrier is denser, the frequency spectrum efficiency is higher, but the subcarrier spacing is smaller and more susceptible to interference and less resistant to attenuation. Therefore, in the selection of subcarrier spacing in the OFDM system, a balance is required between the frequency spectrum efficiency and the resistibility to frequency shift. Under a certain length of the cyclic prefix (depending on the cell size and the multipath channel property), as the subcarrier spacing decreases, the length of the OFDM symbol period increases, and the frequency spectrum efficiency of the system increases. However, an overly small subcarrier spacing may not only be too sensitive to phase noise, but affects the system performance. Therefore, where the complexity of fast Fourier transform (FFT) or other conversion between the time domain and the frequency domain is not taken into account, in the selection mechanism of subcarrier spacing, the smallest possible subcarrier spacing should be adopted under the condition that sufficient capability against frequency shift is maintained.

Then, in response to the measurement report reported by the user equipment 50 or other requirements, the processor 86 may request the base station 100 to reduce the initial subcarrier spacing according to the corresponding resource use condition. In any case, the resource use condition may still change, and the subcarrier spacing may be dynamically increased or reduced accordingly.

In summary of the above, in the embodiments of the disclosure, in the network entity and the resource arrangement method, the resource use condition is analyzed, and the appropriate subcarrier spacing is provided accordingly, thereby conforming to the current application scenario. In addition, in the embodiment of the disclosure, the frequency spectrum use efficiency can be improved, large phase noise and Doppler shift can be resisted, and the overall performance of the system can be effectively improved.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A resource arrangement method, adapted for a network entity, wherein the resource arrangement comprises:
obtaining a resource use condition of a radio resource, wherein the radio resource is configured with a plurality of subcarriers; and
adjusting a subcarrier spacing between the subcarriers according to the resource use condition.

2. The resource arrangement method as described in claim 1, wherein the resource use condition comprises at least one of a frequency, a bandwidth, a phase noise, and a mobility speed related to the radio resource, and the step of adjusting the subcarrier spacing between the subcarriers according to the resource use condition comprises:
in response to an increase of a degree corresponding to the resource use condition, increasing the subcarrier spacing; and
in response to a decrease of the degree, reducing the subcarrier spacing.

3. The resource arrangement method as described in claim 1, wherein the resource use condition comprises at least one of a latency, a cell coverage, and a number of user equipments related to the radio resource, and the step of adjusting the subcarrier spacing between the subcarriers according to the resource use condition comprises:
in response to an increase of a degree corresponding to the resource use condition, reducing the subcarrier spacing; and
in response to a decrease of the degree, increasing the subcarrier spacing.

4. The resource arrangement method as described in claim 1, wherein the step of adjusting the subcarrier spacing between the subcarriers according to the resource use condition comprises:
determining an initial subcarrier spacing according to a cell planning of a base station; and
reducing the initial subcarrier spacing according to the resource use condition.

5. The resource arrangement method as described in claim 1, wherein step of obtaining the resource use condition of the radio resource comprises:
determining the resource use condition according to a measurement report, wherein the measurement report is fed back by a user equipment.

6. A network entity, comprising:
a storage device, configured to store a programming code; and
a processor, coupled to the storage device and configured to be loaded with and execute the programming code to:
obtain a resource use condition of a radio resource, wherein the radio resource is configured with a plurality of subcarriers; and
adjust a subcarrier spacing between the subcarriers according to the resource use condition.

7. The network entity as described in claim 6, wherein the resource use condition comprises at least one of a frequency, a bandwidth, a phase noise, and a mobility speed related to the radio resource, and the processor is further configured to:
in response to an increase of a degree corresponding to the resource use condition, increase the subcarrier spacing; and
in response to a decrease of the degree, reduce the subcarrier spacing.

8. The network entity as described in claim 6, wherein the resource use condition comprises at least one of a latency, a cell coverage, and a number of user equipments related to the radio resource, and the processor is further configured to:
in response to an increase of a degree corresponding to the resource use condition, reduce the subcarrier spacing; and
in response to a decrease of the degree, increase the subcarrier spacing.

9. The network entity as described in claim 6, wherein the processor is further configured to:
determine an initial subcarrier spacing according to a cell planning of a base station; and
reduce the initial subcarrier spacing according to the resource use condition.

10. The network entity as described in claim 6, where the processor is further configured to:
determine the resource use condition according to a measurement report, wherein the measurement report is fed back by a user equipment.
